(19) United States
(12) Patent Application Publication
(10) Pub. No.: US 2002/0097572 A1
(43) Pub. Date: Jul. 25, 2002

(54) Tool having a detachable light device

(76) Inventor: Chang Hsing Yeh, Taichung (TW)

Correspondence Address: CHARLES E. BAXLEY, 59 John Street-5th Floor, New York, NY, 10038, US

(21) Appl. No.: 10/106,629

(22) Filed: Mar. 27, 2002

Related U.S. Application Data
(63) Continuation-in-part of application No. 09/590,181, filed on Jun. 9, 2000, now Pat. No. 6,386,727.

(51) Int. Cl. B25B 23/18

(52) U.S. Cl. 362/119; 362/120

(57) ABSTRACT

A tool includes a housing having a channel for detachably receiving a tool handle and having a chamber for receiving one or more batteries. A socket is pivotally secured to the housing and includes a bore for receiving a light bulb. Two conductor blade are secured to the socket and electrically coupled to the case and the center electrodes of the light bulb. Two conductor arms are secured in the housing and have one end electrically coupled to the conductor blades, even when the socket and the conductor blades are rotated relative to the housing.

The present invention is a continuation-in-part of U.S. patent application No. 09/590,181, filed Jun. 9, 2000. allowed.

### BACKGROUND OF THE INVENTION

1. Field of the Invention

The present invention relates to a tool, and more particularly to a tool having a detachable light device.

2. Description of the Prior Art

U.S. Pat. No. 5,899,554 to Hsu, and U.S. Pat. No. 6,186,638 to Chang disclose two of the typical tools each of which includes a light device solidly retained in the tool handle and may not be easily disengaged from the tool and may not be changed and attached onto the other tools.

The present invention has arisen to mitigate and/or obviate the afore-described disadvantages of the conventional tools.

### SUMMARY OF THE INVENTION

The primary objective of the present invention is to provide a tool including a light device which may be attached onto and disengaged from the tool for allowing the light device to be attached onto various kinds of tools.

In accordance with one aspect of the invention, there is provided a tool comprising a handle including a driving end for fastener driving purposes, and a light device including a housing having a channel formed therein for receiving the handle, and having a chamber formed therein, a socket received in the housing, and pivotally secured to the housing, for allowing the socket to be rotated relative to the housing, the socket including a bore formed therein, a light bulb received in the bore of the socket, the light bulb including a case electrode and a center electrode, at least one battery received in the chamber of the housing and including a center electrode and a case electrode, a first conductor blade secured to the socket and electrically coupled to the center electrode of the light bulb, a second conductor blade secured to the socket and electrically coupled to the case electrode of the light bulb, a pair of conductor arms engaged in the housing and having a first end electrically coupled to the first and the second conductor blades respectively, and having a second end for selectively and electrically coupling to the case electrode and the center electrode of the battery respectively, and switch means for selectively energizing the light bulb. The first and the second conductor blades are arranged to be kept in electrical contact with the conductor arms respectively when the socket and the first and the second conductor blades are rotated relative to the housing.

A transparent cap is further provided and engaged onto the socket for retaining the light bulb in the socket.

The first conductor blade is engaged through the socket, and includes an outer segment bent and engaged onto an outer portion of the socket, and includes an inner end extended inward of the bore of the socket and electrically coupled to the center electrode of the light bulb, the second conductor blade includes a middle segment engaged through the socket and includes an outer segment bent and engaged onto the outer portion of the socket, and includes an inner end extended inward of the bore of the socket and electrically coupled to the case electrode of the light bulb.

The housing includes a pair of orifices formed therein, the first and the second conductor blades each includes an opening formed therein and aligned with the orifices of the housing respectively, the tool further includes a pair of fasteners engaged through the orifices of the housing and the openings of the first and the second conductor blades and engaged with the socket for pivotally securing the socket and the first and the second conductor blades to the housing.

The socket includes a pair of screw holes formed therein and aligned with the openings of the first and the second conductor blades for threading with the fasteners.

The conductor arms each includes an aperture formed therein and aligned with the openings of the first and the second conductor blades for receiving the fasteners.

A casing is further provided and received in the chamber of the housing, the casing includes a space formed therein for receiving the battery.

The housing includes a passage formed between the chamber and the notch thereof, the passage includes a height smaller than that of the chamber of the housing for forming a shoulder between the passage and the chamber of the housing and for engaging with the battery.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a tool having a light device in accordance with the present invention;

FIG. 2 is a perspective view of the tool;

FIG. 3 is a cross sectional view taken along lines 3-3 of FIG. 2;

FIG. 4 is a cross sectional view similar to FIG. 3, illustrating the operation of the light device for the tool; and

4 FIGS. 5 and 6 are perspective views illustrating the conductors for the light device of the tool.

### DETAILED DESCRIPTION OF THE PREFERRED EMBODIMENT

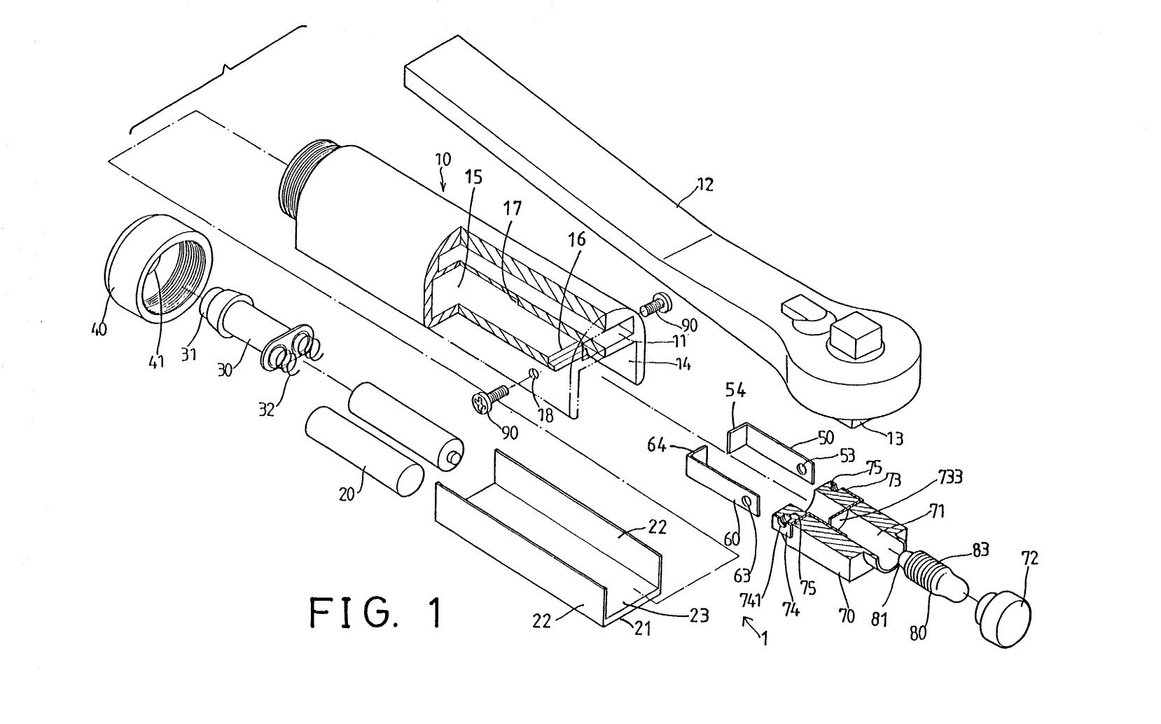

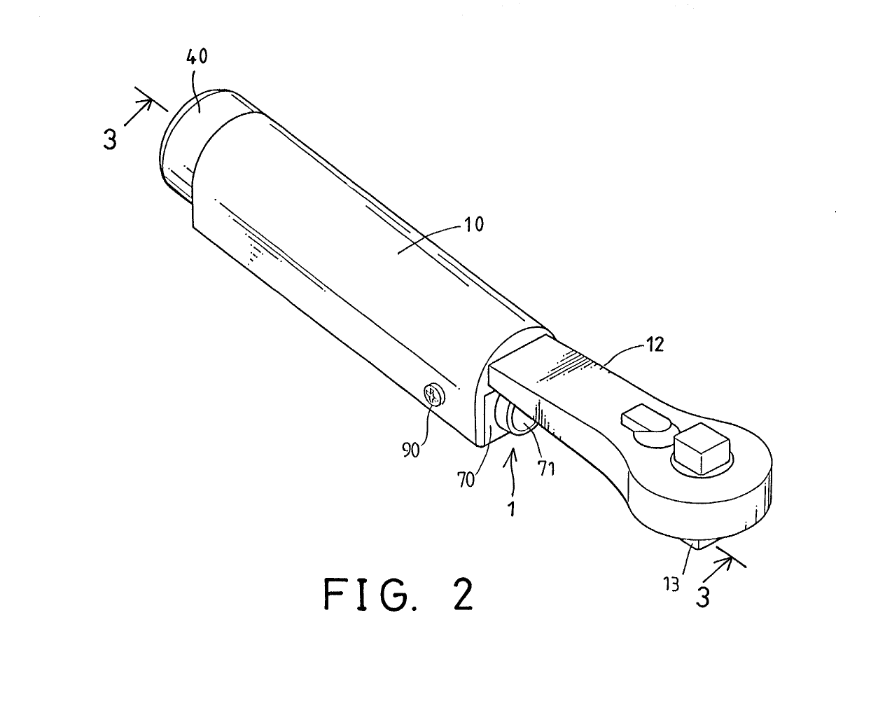

Referring to the drawings, and initially to FIGS. 1-3, a tool in accordance with the present invention comprises a handle 12 including a driving opening or a driving member, such as a ratchet driving member 13 provided in one end thereof for driving the fasteners or the like. A light device 1 is designed to be attached onto and to be disengaged from the tool handle 12 when required, for allowing the light device 1 to be attached onto various kinds of tools. The light device 1 includes a housing 10 having a channel 11 formed therein, such as formed in the upper portion thereof for receiving the handle 12 and for allowing the housing 10 of the light device 1 to be attached onto and to be disengaged from the tool handle 12 when required. The housing 10 may be secured onto the handle 12 with such as the force-fitted engagement or by the other fasteners.

The housing 10 includes a chamber 15 formed in the rear portion thereof for receiving one or more batteries 20 therein. The housing 10 includes an notch 14 formed in the front portion thereof and a passage 16 formed in the middle portion thereof and communicating with the chamber 15 of the housing 10, and includes a pair of orifices 18 formed therein and communicating with the notch 14 of the housing 10, for receiving pins or shafts or rods or fasteners 90 respectively. As shown in FIGS. 1, 3, and 4, the chamber 15 of the housing 10 includes a height greater than that of the passage 16 of the housing 10, for forming a shoulder 17 between the chamber 15 and the passage 16 of the housing 10.

The chamber 15 of the housing 10 preferably includes a width and/or a height equals to that of the batteries 20, for allowing the batteries 20 to be snugly received in the chamber 15 of the housing 10. Alternatively, as shown in FIGS. 1, 3 and 4, a non-conductive casing 21 may further be provided and having a space 23 formed between a pair of opposite or spaced walls 22 for snugly receiving the batteries 20, and for allowing the casing 21 and the batteries 20 to be snugly received in the chamber 15 of the housing 10. The shoulder 17 of the housing 10 may engage with the casing 21 and/or the batteries 20 for limiting the movement of the casing 21 and the batteries 20 relative to the housing 10, and for stably retaining the casing 21 and the batteries 20 within the chamber 15 of the housing 10.

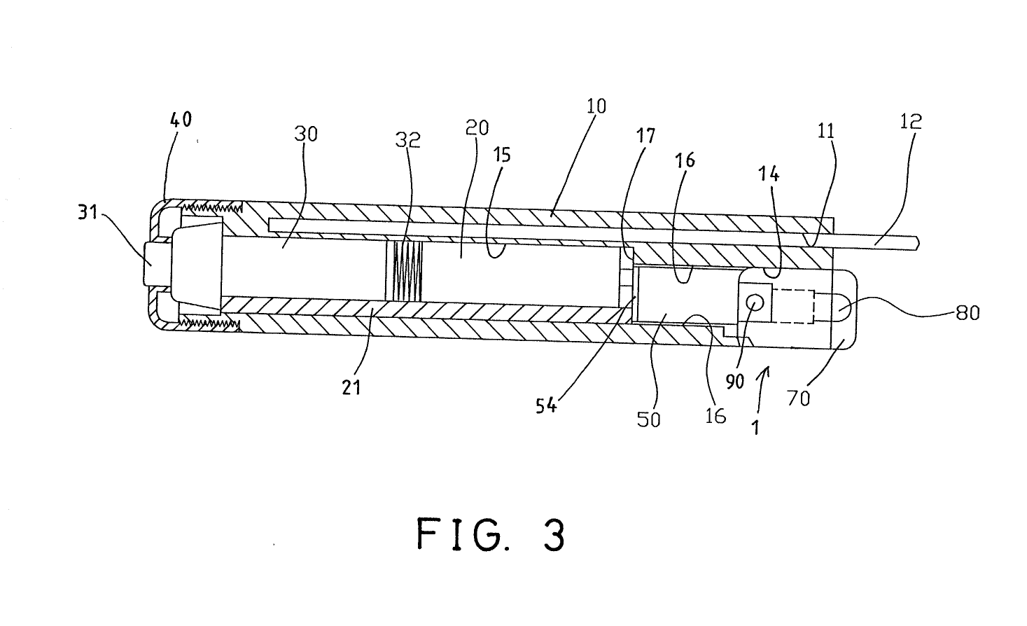

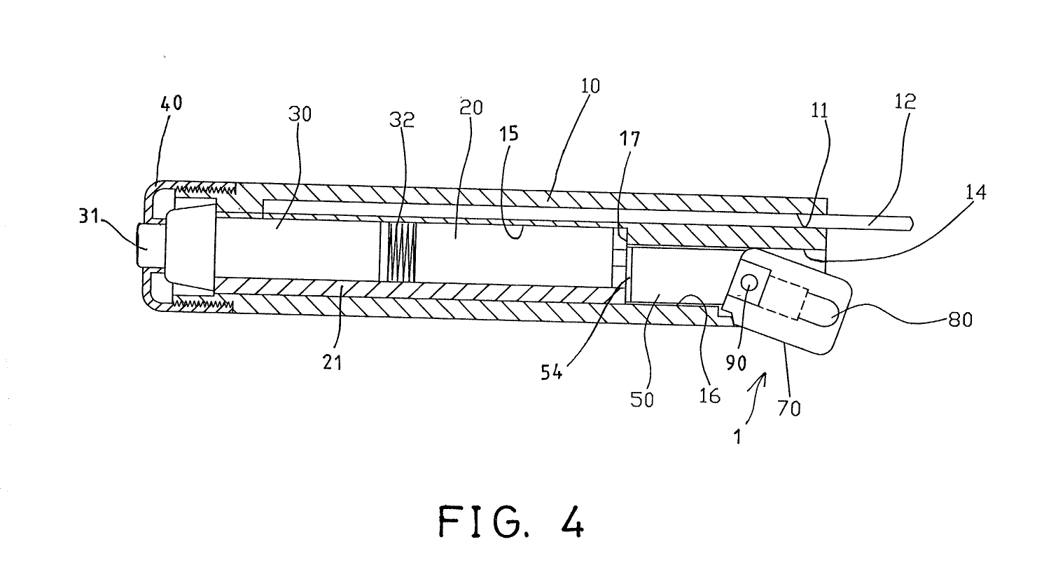

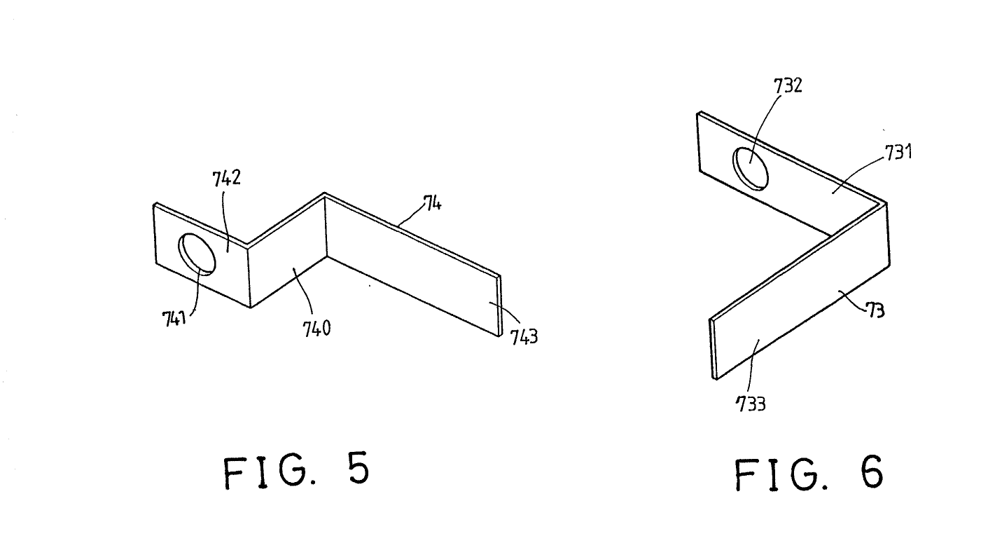

A conductive socket 70 includes a bore 71 formed therein for receiving a light bulb or a light device 80 therein, such as a light emitting diode 80 or a liquid crystal display or the like. As shown in FIG. 1, the cap 72, particularly a transparent cap 72, may further be provided and secured to the socket 70 for shielding or for retaining the light bulb 80 within the socket 70. The socket 70 includes a pair of opposite screw holes 75 formed therein for threading with the fasteners 90. The light device 80 may also be engaged and retained in the bore 71 of the socket 70 without the cap 72 (FIGS. 3, 4).

A conductor blade 73 (FIGS. 1, 6) is engaged through the socket 70, and includes an outer segment 731 bent and engaged onto the outer portion of the socket 70 and having an opening 732 formed therein and aligned with one of the screw holes 75 of the socket 70, and includes an inner end 733 extended inward of the bore 71 of the socket 70 for electrically coupled to or engaged with the center electrode 81 of the light device 80.

Another conductor blade 74 (FIGS. 1, 5) includes a middle segment 740 engaged through the socket 70, and includes an outer segment 742 bent and engaged onto the outer portion of the socket 70 and having an opening 741 formed therein and aligned with the other screw holes 75 of the socket 70, and includes an inner end 743 extended inward of the bore 71 of the socket 70 for electrically coupled to or engaged with the case electrode 83 of the light device 80.

A pair of conductor arms 50, 60 are engaged and retained snugly in the passage 16 of the housing 10, and each has an aperture 53, 63 formed in the front end thereof and aligned with the openings 732, 741 of the conductor blades 73, 74 respectively, and aligned with the orifices 18 of the housing 10, for receiving the fasteners 90 which may rotatably or pivotally securing the socket 70 in the notch 14 of the housing 10, and for allowing the socket 70 to be rotated relative to the housing 10 (FIGS. 3, 4). The conductor arms 50, 60 each includes a bent inner end 54, 64 for engaging with the center electrode and/or the case electrode of the batteries 20.

The bent inner ends 54, 64 of the conductor arms 50, 60 may be kept engaged with and electrically coupled to the conductor arms 50, 60 respectively even when the socket 70 is rotated relative to the housing 10 and the conductor arms 50, 60 about the fasteners 90. The bent inner ends 54, 64 of the conductor arms 50, 60 may be engaged with the center electrode and the case electrode of two adjacent batteries 20, as shown in FIG. 1, but may alternatively be arranged to be engaged with the center electrode and the case electrode of a single battery 20.

A switch 30 is received in the rear portion of the chamber 15 of the housing 10 and includes one or more conductor springs 32 electrically coupled to the electrodes of the batteries 20. The conductor springs 32 may be engaged with the center electrode and the case electrode of two adjacent batteries 20. Alternatively, the conductor springs 32 may be arranged to be engaged with the center electrode or the case electrode of a single battery 20 and one of the conductor arms 50, 60, in order to electrically couple the conductor springs 32 to the center electrodes and the case electrodes of the batteries 20, or of a single battery 20 and the light device 80.

The switch 30 includes a depressible button 31 provided in the rear end thereof and extended outward of the housing 10 for actuating or for controlling the light bulb 80. A cover 40 is secured to the rear end of the housing 10, by such as a threading engagement, and includes an aperture 41 formed therein for receiving the button 31 and for allowing the button 31 to be extended outward of the cover 40 and for allowing the button 31 to be depressed by the users in order to control and energize the light bulb 80.

As shown in the drawings, the case electrode 83 of the light bulb 80 is electrically coupled to the switch 30 via the conductor blade 74 and the conductor arm 60 and the battery 20. The center electrode 81 of the light bulb 80 is electrically coupled to the switch 30 via the conductor blade 73 and the conductor arm 50 and the battery 20. The switch 30 is thus coupled between the center electrode and the case electrode of the light device 80 for electrically coupling the center electrode and the case electrode of the light device 80 together with the conductor blades 73, 74 and the conductor arms 50, 60 and the batteries 20, in order to control the light bulb 80.

Accordingly, the tool in accordance with the present invention includes a light device which may be attached onto and disengaged from the tool for allowing the light device to be attached onto various kinds of tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool comprising:
a) a handle including a driving end for fastener driving purposes, and
b) a light device including:
i) a housing having a channel formed therein for receiving said handle, and having a chamber formed therein,
ii) a socket received in said housing, and pivotally secured to said housing, for allowing said socket to be rotated relative to said housing, said socket including a bore formed therein,
iii) a light bulb received in said bore of said socket, said light bulb including a case electrode and a center electrode,
iv) at least one battery received in said chamber of said housing and including a center electrode and a case electrode,
vi) a first conductor blade secured to said socket and electrically coupled to said center electrode of said light bulb,
vii) a second conductor blade secured to said socket and electrically coupled to said case electrode of said light bulb,
viii) a pair of conductor arms engaged in said housing and having a first end electrically coupled to said first and said second conductor blades respectively, and having a second end for selectively and electrically coupling to said case electrode and said center electrode of said at least one battery respectively, and
ix) switch means for selectively energizing said light bulb.

2. The tool according to claim 1 further comprising a transparent cap engaged onto said socket for retaining said light bulb in said socket.

3. The tool according to claim 1, wherein said first conductor blade is engaged through said socket, and includes an outer segment bent and engaged onto an outer portion of said socket, and includes an inner end extended inward of said bore of said socket and electrically coupled to said center electrode of said light bulb, said second conductor blade includes a middle segment engaged through said socket and includes an outer segment bent and engaged onto said outer portion of said socket, and includes an inner end extended inward of said bore of said socket and electrically coupled to said case electrode of said light bulb.

4. The tool according to claim 3, wherein said housing includes a pair of orifices formed therein, said first and said second conductor blades each includes an opening formed therein and aligned with said orifices of said housing respectively, said tool further includes a pair of fasteners engaged through said orifices of said housing and said openings of said first and said second conductor blades and engaged with said socket for pivotally securing said socket and said first and said second conductor blades to said housing.

5. The tool according to claim 4, wherein said socket includes a pair of screw holes formed therein and aligned with said openings of said first and said second conductor blades for threading with said fasteners.

6. The tool according to claim 4, wherein said conductor arms each includes an aperture formed therein and aligned with said openings of said first and said second conductor blades for receiving said fasteners.

7. The tool according to claim 1 further comprising a casing received in said chamber of said housing, said casing including a space formed therein for receiving said at least one battery.

8. The tool according to claim 1, wherein said housing includes a passage formed between said chamber and said notch thereof, said passage includes a height smaller than that of said chamber of said housing for forming a shoulder between said passage and said chamber of said housing and for engaging with said at least one battery.
